(19) United States
(12) Patent Application Publication
(10) Pub. No.: US 2006/0136525 A1
(43) Pub. Date: Jun. 22, 2006

(54) Method, computer program product and mass storage device for dynamically managing a mass storage device

(76) Inventor: Jens-Peter Akelbein, Bodenheim (DE)

Correspondence Address: DILLION & YUDELL, LLP, 8911 N CAPITAL OF TEXAS HWY, SUITE 2110, AUSTIN, TX, 78759, US

(21) Appl. No.: 11/259,782

(22) Filed: Oct. 27, 2005

(30) Foreign Application Priority Data
Dec. 21, 2004 (EP) 04106787.7

(51) Int. Cl. G06F 17/30

(52) U.S. Cl. 707/204

(57) ABSTRACT

A method, apparatus, and computer-usable medium for dynamically managing a mass storage device. The present invention includes computing an individual score for each data element among a collection of data stored in a secondary storage device. The secondary storage device is partitioned into at least one independent logical volume. In response to comparing an amount of data stored in the secondary storage device with a predetermined upper threshold, the collection of data is sent to at least one tertiary storage device by priority of the individual scores computed for each data element. In response to sending the collection of data, the amount of data stored in the secondary storage device is compared with a predetermined lower threshold. In response to the comparison of the amount of data stored in the secondary storage device with a predetermined lower threshold, the sending of the collection of data is terminated. In response to terminating the sending of the collection of data, at least one independent logical volume in the secondary storage device is resized in proportion to the collection of data stored in the secondary storage device and stored in the independent logical volume.

### PRIORITY CLAIM

This application claims priority of German Patent Application No. DE 04106787.7, filed on Dec. 21, 2004, and entitled, “Method, computer program product and mass storage device for dynamically managing a mass storage device”.

### BACKGROUND OF THE INVENTION

1. Technical Field

The present invention relates in general to the field of data processing systems. More particularly, the present invention relates to the field of implementing mass storage devices within data processing systems. Still more particularly, the present invention relates to a system and method of dynamically managing a mass storage devices within a data processing system.

2. Description of the Related Art

Today, storage resource management (SRM) and hierarchical storage management (HSM) are two application areas where different sorts of software manage the resources of a mass storage device. These resources comprise logical volumes and file systems assigned to said logical volumes.

Logical volumes reside on physical storage devices. They are provided to a set of hosts which manage file systems on these logical volumes. A host can manage multiple file systems independently. Multiple logical volumes are required for storing the data. In a consolidated storage environment they reside on a single storage device, e.g. an enterprise storage server (ESS). Furthermore, a set of hosts can share a single storage device by using a storage area network. All logical volumes provided to the hosts share the same physical disk space/hard disks within the storage device. If more space is needed for a single file system the logical volume can be expanded. If less storage capacity is required the logical volume size can be adjusted to requirements. SRM software is used for this. Adjustments can be carried out manually or can be monitored and automatically adjusted.

HSM solutions allow files to be placed on secondary and tertiary storage devices, e.g. disk storages (secondary) and tape storages (tertiary), by defining a placement policy. HSM allows a transparent access to this data. If a file resides on tape it will be recalled automatically so that an application does not need to know about the placement of a file. This distinguishes HSM solutions from archival solutions where the location of archived data need to be known be applications.

Usually, the policy is given by the size and the age of a file, but policies considering more attributes of a file can also be applied. Old and large data is called reference data as it exists on for reference e.g. to fulfill retention policies given by law in most of the cases. Data, e.g. files, need to be retained which are not accessed frequently and will be better stored on tertiary storage.

Today's HSM solutions manage each file system on its own. High and low thresholds can be defined that guarantee a minimum and maximum amount of data residing on the disk storage. This allows that a file system will not run into an out-of-disk-space condition. Furthermore, the file system is periodically scanned to determine candidates for migration. Here, the size of a file is also a valid criterion as large files consume a lot of disk space. If they are migrated to tape a lot of disk space can be saved. Therefore HSM solutions determine a score for each data in each particular file system to measure the eligibility of a migration candidate quantitatively. By applying a policy based on age and size these attributes can be used to compute a score reflecting the eligibility of a file. Policies considering a different set of attributes can also be used to compute a quantitive measurement of the eligibility of an individual file. A HSM application migrates data with the highest score in each particular file system when the amount of used capacity of the disk storage exceeds the high threshold. This will take place as long as the amount of used capacity of the disk is above the low threshold of a file system. So a HSM application ensures to have the amount of used capacity of the disk between both thresholds. Instead of thresholds other triggers can also be applied to allow a migration status of each file based on the policies defined for each file system.

The drawback of the state of the art is, that if a file system contains a lot of active data frequently accessed, some of these data are migrated from the disk storage to the tape storage by the HSM, since the HSM only considers the score of the data to be migrated within the particular file system. Because these data are often used, the physical storage device will lose performance since these data have often to be swapped between disk and tape. Another drawback of the state of the art is, that the size of the logical volumes of the assigned file systems cannot be changed dynamically, since the HSM will migrate active data from active file systems to tape before the SRM would react and automatically adjust the size of the logical volume of the assigned file system. Furthermore a default size for the different file systems is useless, since data contained in different file systems can be more or less active within different periods of time. If other triggers are used instead of thresholds for data migration this results in comparable situations.

### SUMMARY OF THE INVENTION

The first part of the invention's technical purpose is met by the proposed method for managing a mass storage device comprising at least one secondary storage device and at least one tertiary storage device connectable with said secondary storage device, wherein said secondary storage device is partitioned into independent logical volumes assigned to different file systems to be used for storing data of different applications, that is characterized in
that an individual score or another eligibility criterion is computed for every data stored on this secondary storage device,
wherein by exceeding an upper limit for the amount of used capacity of the secondary storage device defined by an upper threshold or by another event triggering data migrations, data are swapped to the tertiary storage device in the order of their individual scores or another eligibility criterion until a lower limit for the amount of used capacity of the secondary storage device defined by an lower threshold is reached or all files fulfilling the eligibility criterion are migrated, and
that the size of the logical volumes is changed dynamically, wherein the size of the individual logical volumes is adapted proportional to the data remaining on the secondary storage device and belonging to the particular logical volume.

Thereby the term score also comprises other eligibility criterions, e.g. derived from the policies specified for the specific mass storage device.

The secondary storage device is preferably a disk storage, wherein the tertiary storage device is preferably a tape storage. The upper threshold preferably is defined as a percentage in the range of 0 to 100% or as a number between 0 and 1 describing the maximum allowable amount of used capacity of the secondary storage device divided by the overall secondary storage device. A similar definition can be used for the lower threshold. By this definition, the thresholds can also be used for one logical volume, so that the swapping of data and the dynamically resizing of the logical volumes can also be conducted when the amount of used capacity of one logical volume exceeds the upper threshold of the storage capacity of said logical volume.

The same method applies also where different classes of disk storage like e.g. Enterprise level disk storage, cheap RAID arrays and the like are combined as a hierarchical storage system. Thereby it is also thinkable to use other events than the amount of used capacity of the secondary storage for triggering the data migrations between the secondary and the tertiary storage device, like e.g. a periodic schedule that triggers data migrations between the secondary and the tertiary storage device.

The proposed method for managing a physical storage device has the advantage over the state of the art that the most feasible set of reference data is migrated to tertiary storage, e.g. tape from the overall amount of data and not from a single file system. This can be on a single host or a set of hosts sharing the same secondary storage device, e.g. a disk storage. This secondary storage device will be used for the most active data of all file systems managed together while the most passive data, e.g. reference data, within all file systems is migrated to tape. Furthermore, the most active file systems will grow in their size automatically while passive file systems get less and less space on the secondary storage device over the time. Therefore, unnecessary data movements between the secondary storage device and the tertiary storage device, e.g. between disk storage and tape storage are avoided. All file systems can be taken into consideration for the best placement of data. By this proceeding, the performance of the physical storage device will not be constrained more than absolutely needed by permanently swapping data required from active file systems from disk to tape and vice versa.

In a preferred embodiment of the invention, also a global score spanning the logical volumes on the secondary storage device is computed for all data stored on this secondary storage device, or a global eligibility criterion is derived from the policies specified for the mass storage device, wherein by exceeding an upper limit for the amount of used capacity of the secondary storage device defined by an upper threshold, all data with an individual score higher than the global score are swapped to the tertiary storage device, or all files fulfilling the eligibility criterion are swapped to the tertiary storage device.

The core idea is to use a global score as migration criteria. The new method computes a global score. All files with a score above or equal this global score get migrated within all file systems. While some file systems may get emptied near to 0% if all data is reference data, other file systems might be left as they are. When the amount of used capacity of the physical storage device or the amount of used capacity of one logical volume exceeds the upper threshold, data will be migrated to tape, wherein the amount and kind of data is determined by adding the size of all files with the highest global score spanning all the logical volumes as long as enough disk space will be freed up on the storage device for reaching the lower threshold. Therefore, a high and low threshold for all logical volumes on the secondary storage is defined.

Alternatively, an eligibility criterion is computed for each individual file reflecting the current policy settings. All files eligible for migration will be migrated after the next event triggering takes place.

After all files eligible are migrated using the global score criteria or being selected by an eligibility criterion, the logical volume the size of all logical volumes is adjusted. The resizing adjusts the logical volumes to that they all have the same percentage of free disk space. Active file systems remain unchanged or might be increased in their size while passive file systems are shrinked in their size.

In a preferred embodiment of the invention, swapping of data from the secondary storage device to the tertiary storage device and dynamically adapting the size of all logical volumes will take place when the amount of used capacity of at least one logical volume exceeds the upper threshold or another event triggered the swapping of data, wherein the upper threshold is preferably defined as a percentage of used capacity of the secondary storage. Alternatively, the alteration of logical volumes sizes takes place after all data migrations triggered by an event are finished.

In a preferred embodiment of the invention, the individual scores and/or the global score is computed always when a storage access occurs.

In another preferred embodiment of the invention, at least the individual score of a specific data is always computed when a storage access concerning said data occurs. Preferably the global score will also be computed simultaneously.

In another preferred embodiment of the invention, the individual scores and/or the global score is computed in defined periods. Instead of computing individual and global scores, it is also thinkable to compute other individual and global eligibility criteria in defined periods.

In another preferred embodiment of the invention, the period is defined by the amount of used capacity of the secondary storage device exceeding the upper threshold.

In an additional preferred embodiment of the invention, the period is a time period.

In an additional preferred embodiment of the invention, the period is defined as ending when a scheduled or another external event takes place.

In an additional preferred embodiment of the invention, each time data are swapped from the secondary storage device to the tertiary storage device, the size of each logical volume is dynamically changed to 1.25 times the size of the data of said logical volume remaining on said secondary storage device.

In an additional preferred embodiment of the invention, the lower threshold is 80% of the storage capacity of the secondary storage device.

In a particularly preferred embodiment of the invention, said method is performed by a computer program product stored on a computer usable medium comprising computer readable program means for causing a computer to perform the method mentioned above, when said computer program product is executed on a computer.

A preferred embodiment of the present invention includes a mass storage device, comprising at least one secondary storage device and at least one tertiary storage device as well as means to administrate the data stored on said mass storage device, wherein the mass storage device is used for storing data of different file systems and at least the secondary storage device is partitioned into logical volumes assigned to different file systems, which mass storage device is characterized in that the means to administrate the data stored on said mass storage device comprise means to get information at least about the amount of used capacity of the secondary storage, means to compare the used capacity of the secondary storage with an upper threshold, means to compute the used capacity of the secondary storage device at a lower threshold, means to compute an individual score for each particular data stored on said mass storage device, means to initialize a migration of data from the secondary to the tertiary storage device according to the order of their individual scores until the lower threshold is reached, and means to change the size of the logical volumes on the secondary storage device proportional to the data remaining on the secondary storage device and belonging to the particular logical volume.

In a preferred embodiment of the mass storage device according to the invention, the means to administrate the data stored on said mass storage device comprise means to compute a global score spanning the logical volumes on the secondary storage device and defining data with a higher individual score than the global score to be migrated to reach the lower threshold, means to compare the individual scores of the data stored on the secondary storage device with the global score, and means to migrate data with an individual score higher than the global score.

In another preferred embodiment of the mass storage device according to the invention, the means to administrate the data stored on said mass storage device comprise means to get information about the amount of used capacity of the particular logical volumes on the secondary storage.

The above-mentioned features, as well as additional objectives, features, and advantages of the present invention will become apparent in the following detailed description.

### BRIEF DESCRIPTION OF THE FIGURES

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 illustrates an exemplary physical storage device partitioned into four independent logical volumes assigned to four different file systems to be utilized for storing data of two different file servers according to a preferred embodiment of the present invention;

FIG. 2 depicts the amount of used capacity of the logical volumes of the physical storage device shown in FIG. 1 and the type of data stored in these logical volumes according to a preferred embodiment of the present invention;

FIG. 3 illustrates a situation where the amount of used capacity of two file systems has exceeded the upper threshold and the migration started using a hierarchical storage management according to a preferred embodiment of the present invention;

FIG. 4 depicts a situation where the size of two file systems has been changed by a storage resource management according to a preferred embodiment of the present invention;

FIG. 5 illustrates a classification of data in all file systems into reference data and active data utilizing a global score according to a preferred embodiment of the present invention.

FIG. 6 depicts the migration of data having an individual score equal or higher than the global score from secondary to tertiary storage device according to a preferred embodiment of the present invention;

FIG. 7 illustrates a situation after migration of data and alteration of the size of the logical volumes according to a preferred embodiment of the present invention; and

FIG. 8 depicts the execution of the exemplary method of dynamically managing a mass storage device according to a preferred embodiment of the present invention.

### DETAILED DESCRIPTION OF A PREFERRED EMBODIMENT

As shown in FIG. 1, today a single file server 1 can manage multiple file systems 2, 2′ that reside on a single physical storage device 5 like an ESS or a SVC within different logical volumes 3, 3′. With a SAN the storage device 5 can also be shared between different file servers 1, 1′ so that a high number of file systems 2, 2′ 2″, 2′″ reside on the same storage device 5.

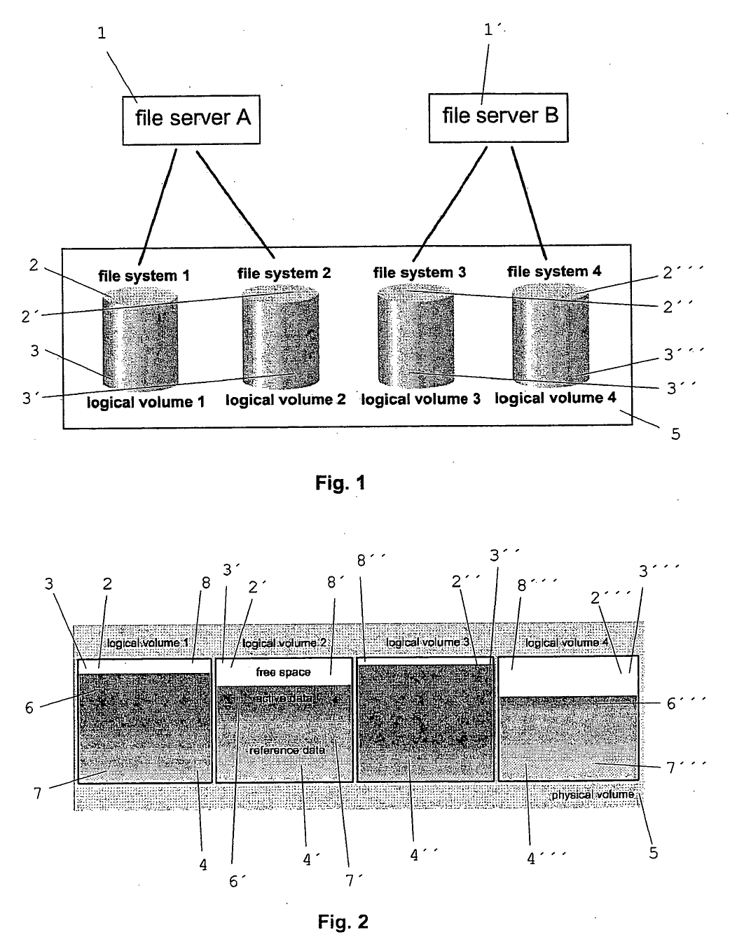

FIG. 1 shows two machines 1, 1′ managing two file systems 2, 2′ and 2″, 2′″ each. The file systems 2, 2′ 2″, 2′″ are assigned to the particular logical volumes 3, 3′, 3″, 3′″ wherein all of the data 4, 4′, 4″, 4′″ stored in these file systems 2, 2′ 2″, 2′″ resides within the same storage device 5 as shown in FIG. 2. Most likely, a higher number of file systems 2 are managed on the same storage device 5.

Like shown in FIG. 2, all of the file systems 2, 2′ 2″, 2′″ are containing active data 6, 6′, 6″, 6′″ (shown in dark grey) that is changed an accessed quiet frequently while other data 7, 7′, 7″, 7′″ is kept for reference (shown in light grey). It gets accessed and changed rarely. Typically, a spectrum from highly active data 6 to reference data 7 nearly never accessed can be found (shown as greyscale changing from dark to light continuously).

So like shown in FIG. 2, the distribution of active data vs. Reference data changes from file system to file system. Also the free space 8, 8′, 8″, 8′″ (shown as white color) within a file system 2, 2′ 2″, 2′″ differs.

If such file systems 2, 2′ 2″, 2′″ are managed by hierarchical storage management, HSM, a high and low threshold is defined for each file system 2, 2′ 2″, 2′″. The thresholds should guarantee that free space 8, 8′, 8″, 8′″ is always available within each file system 2, 2′ 2″, 2′″. If the amount of used capacity of a logical volume 3, 3′, 3″, 3′″, e.g. the amount of stored data 4, 4′, 4″, 4′″ in a file system 2, 2′ 2″, 2′″ reaches the high threshold a data migration starts to migrate eligible migration candidates that were identified as reference data 7, 7′, 7″, 7′″ by file system scans within the particular file systems 2, 2′ 2″, 2′″ exceeding the upper threshold.

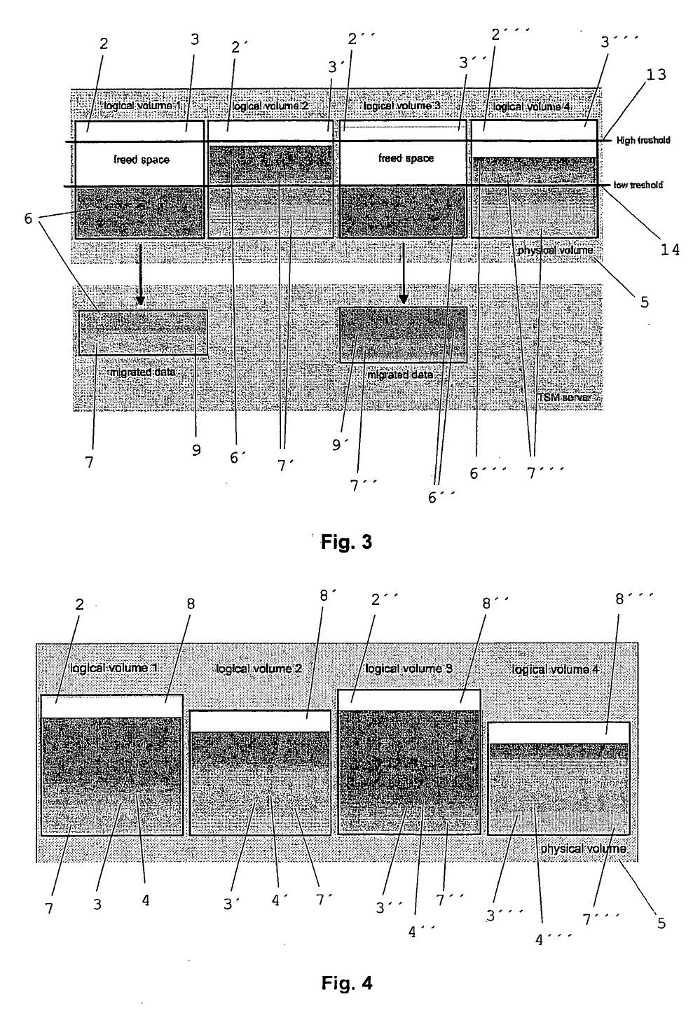

FIG. 3 shows a situation where two files systems 2, 2″ were filled above the high threshold 13. The data migration started using HSM. At the end of the migration processes the situation is like shown in FIG. 3. Data 9, 9′ got migrated to tertiary tape storage until the low threshold 14 is reached. If the distribution between active 6, 6′, 6″, 6′″ and reference 7, 7′, 7″, 7′″ data is unequal within the different file systems 2, 2″ active data 6, 6″ that will frequently be recalled will be migrated. The situation showed in FIG. 3 is typical for an unbalanced usage of multiple file systems according to the state of the art. The identifiable problem is that some file systems 2, 2″ would need a bigger logical volume 3, 3″ because they are populated with much more active data 6, 6″ than other file systems 2′, 2′″. The later ones can be even smaller because they contain a lot of reference data 7′, 7′″.

By using storage resource management, SRM, according to the state of the art a situation as shown in FIG. 4 will occur.

FIG. 4 shows a scenario where the size of the logical volumes 3, 3′, 3″, 3′″ is changed by SRM so that each logical volume 3, 3′, 3″, 3′″ has the same amount of free space 8, 8′, 8″, 8′″. As no HSM is used in FIG. 4 the amount of data 4, 4′, 4″, 4′″ stored on the physical volume 5 remains the same. Now all file systems 2, 2′, 2″, 2′″ have enough space again. Nevertheless, a lot of space is used by reference data 7, 7′, 7″, 7′″ in this scenario.

By combining an HSM concept with the capability of changing logical volume sizes by SRM the most appropriate data of a set of file systems can be determined to be placed on tape while enough free space for all file systems to be filled up is provided too.

This avoids situations where active file systems 2, 2″ create a lot of unnecessary data movements for accesses on migrated data because too less disk space is assigned to this file system while passive file systems reside on the same disk storage consuming disk space for reference data never migrated.

Merging the advantages of both concepts by migrating reference data from secondary to tertiary storage and changing the size of the logical volumes will enable HSM to migrate the most feasible candidates in the overall FIG. This means that only data with a very high score, i.e. eligibility based on HSM candidates criteria are migrated. So if all candidates lists of the different file systems are put together HSM can determine a global score that defines the minimum score files getting migrated. Usually HSM migrates data as long as the low threshold is reached. To determine a global score the size of all files with the highest score needs to be added to the candidates list. This allows to add the space consumed by files with high individual scores as long as a given amount of space is reached, e.g. 20% of the overall disk space of all file systems. Alternatively, all files fulfilling an eligibility criterion based on policies get migrated while the logical volume sizes can be adjusted to the appropriate size.

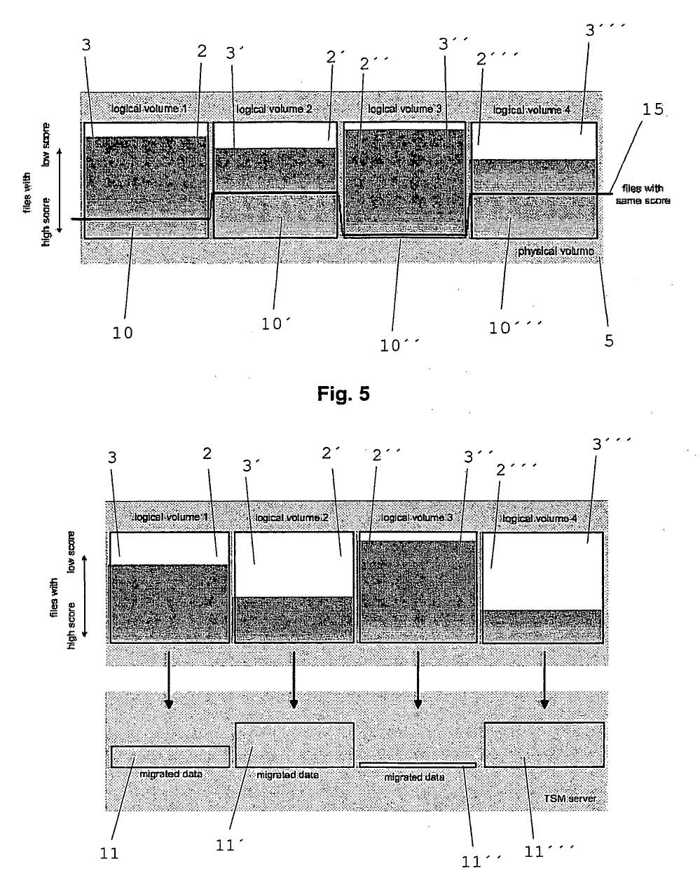

The borderline 15 in FIG. 5 shows the space usage of data 10, 10′, 10″, 10′″ in all file systems having an individual score equal or higher than the global score. The eligibility of each data is the indicator that the data is part of the reference data hosted in the different file systems 2, 2′, 2″, 2′″ assigned to the logical volumes 3, 3′, 3″, 3′″. The next step will be to migrate all data 10, 10′, 10″, 10′″ with an individual score higher than the global score which as been determined as the migration level. So the migration method implements a “score based migration” or “overall threshold migration” instead of the current threshold migrations HSM implements for one file system.

FIG. 6 shows the migration of the data 11, 11′, 11″, 11′″ from secondary to tertiary storage device having an individual score equal or higher than the global score. The best candidates within all file systems 2, 2′, 2″, 2′″ get migrated. These candidates are the data 10, 10′, 10″, 10′″ (light grey) of FIG. 5. This proceeding does not lead to an adjustment of the thresholds. Like in logical volume three (reference numeral 3″), it can be seen that there is still less free space left while logical volume four (reference numeral 3″) has lots of free space. So now the sizes of the logical volumes 3, 3′, 3″, 3′″ need to be adjusted. There are different approaches that can be chosen. One of the easiest is to adjust the size of the logical volume 3, 3′, 3″, 3′″ in a manner that a given percentage of free space is available in all logical volumes 3, 3′, 3″, 3′″.

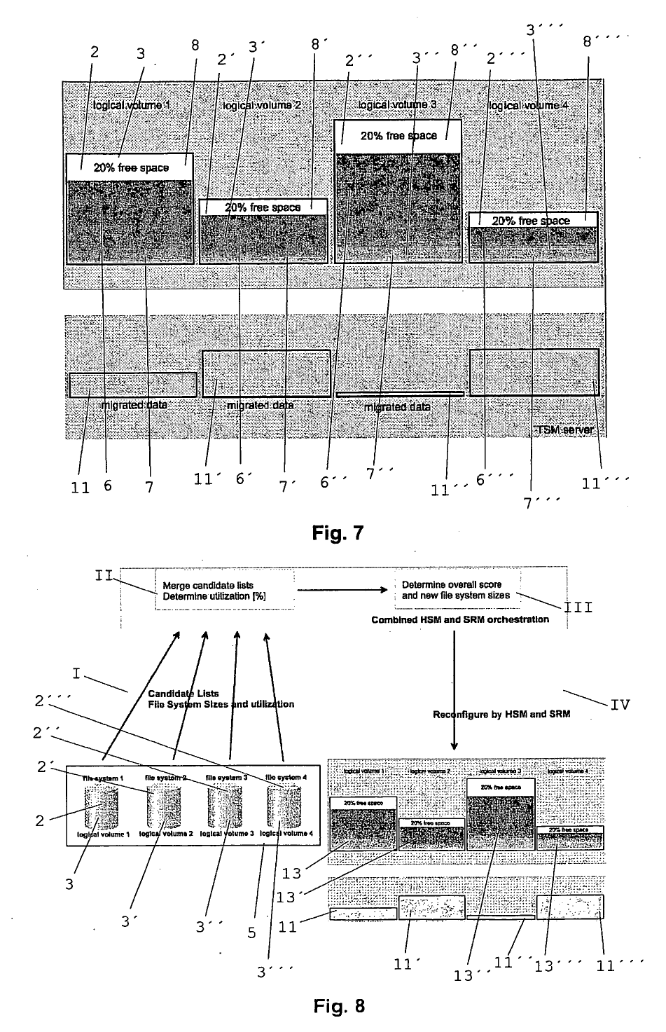

Now the situation shown in FIG. 7 looks much better compared to FIG. 3 (HSM) or only resizing a logical volume by SRM like shown in FIG. 4. In FIG. 7 the most feasible data 11, 11′, 11″, 11′″ are migrated from secondary disk storage to tertiary tape storage. And there is enough free space 8, 8′, 8″, 8′″ left now in each file system 2, 2′, 2″, 2′″. With 20% free space the same effect is gained like with low threshold of 80%. If more active data 6, 6′, 6″, 6′″ are stored in a particular file system 2, 2′, 2″, 2′″ the size of the specific logical volume 3, 3′, 3″, 3′″ belonging to that file system 2, 2′, 2″, 2′″ will be adapted dynamically. In FIG. 7 the file systems 2 and 2″ accommodate more active date 6, 6″, wherein the file systems 2′ and 2″″ accommodate more reference data. Since the data stored in the file systems 2 and 2″ will be accessed more frequently than the data stored in the file system s 2′ and 2′″, most of the data feasible to migration are from file systems 2′ and 2′″. The dynamical alteration of the size of the logical volumes 3, 3′, 3″, 3′″ will lead to an increased size for the logical volumes 3, 3″ and a shrinked size of the logical volumes 3′, 3′″. So the size of the logical volumes 3, 3″ assigned to the file systems 2, 2″ is now much more appropriate while file systems 2′, 2′″ containing more reference data 7′, 7′″ have a smaller logical volume 3′, 3′″ now. The same steps can be repeated each time they are required so they define a workflow.

The whole approach can be carried out as a sort of orchestrating the different steps into one workflow. HSM needs to be enabled to provide all candidate lists from the different HSM instances. Another instance needs to determine the overall score. This action can be triggered on each HSM instance by a high threshold. So if one instance reaches the threshold the workflow starts. The score is distributed back to all HSM instances that start to migrate candidates until all data with an individual score higher than the global score are migrated. After the appropriate candidates got migrated the resizing of the logical volumes 3, 3′, 3″, 3′″ can take place. In addition, a demand migration is also required if a file system 2, 2′, 2″, 2′″ is filled up faster than the process can react.

FIG. 8 shows the execution of the method according to the invention. In step I the individual scores of all data stored on the secondary storage device are computed. These scores are comprised in individual candidate lists of each file system 2, 2′, 2″, 2′″. Also the sizes of the file systems 2, 2′, 2″, 2′″ according the logical volumes 3, 3′, 3″, 3′″ and their utilization, i.e. the amount of used capacity of the particular logical volumes 3, 3′, 3″, 3′″ are acquired. After this, the individual candidate lists are merged to a global candidate list in step II. In step II also the amount of used capacity of the secondary storage device is computed. If the amount of used capacity of the secondary storage device 5 or at least of one logical volume 3, 3′, 3″, 3′″ exceeds the upper limit for the amount of used capacity of the secondary storage device defined by an upper threshold, a global score is computed in step III that determines the data 11, 11′, 11″, 11′″ to be migrated to the tertiary storage device. Also the new sizes of the file systems 2, 2′, 2″, 2′″ are determined in step III. In step IV a combined HSM and SRM orchestration will take place, wherein all data with an individual score higher than the global score are swapped to the tertiary storage device 12 and the size of the logical volumes 3, 3′, 3″, 3′″ is changed dynamically, wherein the size of the individual logical volumes 3, 3′, 3″, 3′″ is adapted proportional to the new sizes of the file systems 2, 2′, 2″, 2′″ according to the data 13, 13′, 13″, 13′″ remaining on the secondary storage device 5 and belonging to the particular logical volume 3,3′,3″,3′″.

Current HSM solutions according to the state of the art apply policies describing the eligibility of a file by its different attributes. Typical attributes used to characterize a file are: file size, age of a file, last access, access frequency, ownership by user and group, file type, directory containing the file, quality of service (QoS) specifications, and other attributes. Policies are used to evaluate the combined set of attributes of each file and determine a definite criteria of how eligible a file is as migration candidate.

As an example, the two attributes age and size can be used to compute a score for each file. This is done by the following equation:
(score of file):=(age of file)*(age factor)+(size of file)*(size factor)
where the age and the size factor can be adjusted to specify whether the age or the size of a files is more important as being migration candidates. A candidate search parses a file system and creates a list of migration candidates sorted by the score of a file. Similar policies can be derived from other combinations of attributes evaluated as migration criteria. Today's HSM solutions use the candidate list of a file system by migrating candidates into the storage repository as long as the file system usage dropped beneath the low threshold.

According to the invention all candidate lists of file systems residing on the same physical disk storage device are evaluated together. As storage gets reassigned between the different file systems and the logical volumes where the file systems reside in the absolute value of the threshold of each file system has to be determined. Therefore, the overall amount of storage to be migrated has to be determined first.

Let CPₜₒₜₐₗ:=SUM(CP_{FS1}, . . . , CP_{Fsi}, . . . , CP_{Fsn})+CP_{free} where CPₜₒₜₐₗ is the total amount of physical disk capacity of the storage device, CP_{Fsi} is the amount of used physical disk capacity of the file system I, and C_{free} is the physical disk capacity currently not used.

Let SUₜₒₜₐₗ:=,SUM (CU_{FS1}, . . . , CU_{Fsi}, . . . , CU_{Fsn}) where CVₜₒₜₐₗ is the total amount of used physical disk capacity and CU_{Fsi} is the amount of used physical disk capacity of the file system I.

Let CVₜₒₜₐₗ:=SUM (CV_{FS1}, . . . , CV_{Fsi}, . . . , CV_{Fsn}) where CVₜₒₜₐₗ is the total amount of used virtually used capacity combining disk based storage an the background storage repository containing data being migrated, and where CV_{Fsi} is the amount of virtually used capacity of the file system I.

Let THₜₒₜₐₗ (0, . . . , 1) be the high threshold for the disk capacity used by all file systems residing on the storage device.

So if CUᵢ/CPᵢ>THₜᵢₜₐₗ is true for i at least one file system 1, . . . , n, an iteration Stepp should be issued.

For the iteration step C_{Delta}:=CUₜₒₜₐₗ−CPₜₒₜₐₗ*THₜₒₜₐₗ, where C_{Delta} is the amount of data eligible for migration if C_{Delta}>0 while only a reassignment of physical disk storage between the different file systems and their underlying logical volumes should be carried out for C_{Delta}<=0.

So if C_{Delta}>0 is true all candidate lists from file systems 1, . . . , n are joined into one candidate list sorted by the score of each individual file. Starting at the beginning of the list, files f₁, . . . , fⱼ, . . . , fₘ are selected and being migrated as long as the sum of the size of all files are<C_{Delta}. When SUM(f₁, . . . , fⱼ, . . . , fₘ)>=C_{Delta}>0 gets true the migration process is being stopped.

For any file system, a new disk capacity CU_{Fsi(t+1)} of the underlying volume is determined, e.g. by using a df command on UNIX. As the next Step, a new CP_{Fsi} for each file system i computed by CP_{Fsi(t+1)}=CU_{Fsi(t+1)}/THₜₒₜₐₗ. All logical volumes get adjusted to SP_{Fsi(t+1)}. After finishing this Step, the iteration ends.

This algorithm is appropriate as an example for a score derermined by the formula to determine the score of a file. Modifications need to be carried out for other attributes not representable as cardinal numbers.

Also, it should be understood that at least some aspects of the present invention may be alternatively implemented in a computer-readable medium that stores a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method for managing a mass storage device, wherein said mass storage device includes at least one secondary storage device and at least one tertiary storage device coupled to said at least one secondary storage device, wherein said secondary storage device is partitioned into at least one independent logical volume, said method comprising:
computing an individual score for each data element among a plurality of data stored in said at least one secondary storage device;
in response to comparing an amount of data stored in said at least one secondary storage device with a predetermined upper threshold, sending said plurality of data to said at least one tertiary storage device by priority of said individual score of each data element;
in response to said sending, comparing said amount of data stored in said at least one secondary storage device with a predetermined lower threshold;
in response to comparing said amount of data stored in said at least one secondary storage device with a predetermined lower threshold, terminating said sending of said plurality of data to said at least one tertiary storage device; and
in response to said terminating, dynamically resizing said at least one independent logical volume in proportion to said plurality of data stored in said at least one secondary storage and stored in said at least one independent volume.

2. The method according to claim 1, further comprising:
computing a global score for said plurality of data stored on said at least one secondary storage device; and
in response to comparing said amount of data stored in said at least one secondary storage device with said predetermined upper threshold, sending each data element with an associated said individual score that exceeds said global score to said at least one tertiary storage device.

3. The method according to claim 2, wherein said computing a global score further comprises:
in response to a storage access to said at least one secondary storage device, computing said global score.

4. The method according to claim 1, wherein said resizing further comprises:
dynamically resizing said at least one independent logical volume, in response to comparing said plurality of data stored in said at least one independent logical volume to said predetermined upper threshold.

5. The method according to claim 1, wherein said computing an individual score further comprises:
computing said individual score for a respective data element of said plurality of data, in response to a storage access to said respective data element.

6. A data processing system comprising:
a processor;
a system memory, coupled to said processor via an interconnect,
a mass storage device, coupled to said processor and said system memory via said interconnect, said mass storage device utilized for storing a plurality of data in a plurality of file systems, wherein said mass storage device further includes:
at least one secondary storage device partitioned into at least one independent logical volume assigned to said plurality of file systems;
at least one tertiary storage device;
computing an individual score for each data element among a plurality of data stored in said at least one secondary storage device;
in response to comparing an amount of data stored in said at least one secondary storage device with a predetermined upper threshold, means for sending said plurality of data to said at least one tertiary storage device by priority of said individual score of each data element;
in response to said sending, means for comparing said amount of data stored in said at least one secondary storage device with a predetermined lower threshold;
in response to comparing said amount of data stored in said at least one secondary storage device with a predetermined lower threshold, means for terminating said sending of said plurality of data to said at least one tertiary storage device; and
in response to said terminating, means for dynamically resizing said at least one independent logical volume in proportion to said plurality of data stored in said at least one secondary storage and stored in said at least one independent volume.

7. The data processing system according to claim 6, further comprising:
means for computing a global score for said plurality of data stored on said at least one secondary storage device; and
in response to comparing said amount of data stored in said at least one secondary storage device with said predetermined upper threshold, means for sending each data element with an associated said individual score that exceeds said global score to said at least one tertiary storage device.

8. The data processing system according to claim 7, wherein said means for computing said global score further comprises:
in response to a storage access to said at least one secondary storage device, means for computing said global score.

9. The data processing system according to claim 6, further comprising:
means for dynamically resizing said at least one independent logical volume, in response to comparing said plurality of data stored in said at least one independent logical volume to said predetermined upper threshold.

10. The data processing system according to claim 6, wherein said means for computing an individual score further comprises:
means for computing said individual score for a respective data element of said plurality of data, in response to a storage access to said respective data element.

11. A computer-usable medium embodying computer program code, said computer program code comprising computer executable instructions configured for:
computing an individual score for each data element among a plurality of data stored in at least one secondary storage device, wherein said at least one secondary storage device is partitioned into at least one independent logical volume;
in response to comparing an amount of data stored in said at least one secondary storage device with a predetermined upper threshold, sending said plurality of data to at least one tertiary storage device by priority of said individual score of each data element;
in response to said sending, comparing said amount of data stored in said at least one secondary storage device with a predetermined lower threshold;
in response to comparing said amount of data stored in said at least one secondary storage device with a predetermined lower threshold, terminating said sending of said plurality of data to said at least one tertiary storage device; and
in response to said terminating, dynamically resizing at said least one independent logical volume in said at least one secondary storage device in proportion to said plurality of data stored in said at least one secondary storage and stored in said at least one independent logical volume.

12. The computer-usable medium of claim 11, wherein said computer executable instructions further comprise computer executable instructions configured for:
computing a global score for said plurality of data stored on said at least one secondary storage device; and
in response to comparing said amount of data stored in said at least one secondary storage device with said predetermined upper threshold, sending each data element with an associated said individual score that exceeds said global score to said at least one tertiary storage device.

13. The computer-usable medium of claim 12, wherein said computer executable instructions configured for computing said global score further comprises computer executable instructions configured for:
in response to a storage access to said at least one secondary storage device, computing said global score.

14. The computer-usable medium of claim 11, wherein said computer executable instructions further comprise computer executable instructions configured for:
dynamically resizing said at least one independent logical volume, in response to comparing said plurality of data stored in said at least one independent logical volume to said predetermined upper threshold.

15. The computer-usable medium of claim 11, wherein said computer executable instructions for computing an individual score further comprises computer executable instructions configured for:
computing said individual score for a respective data element of said plurality of data, in response to a storage access to said respective data element.
